(19) United States
(12) Patent Application Publication
(10) Pub. No.: US 2026/0060264 A1
(43) Pub. Date: Mar. 5, 2026

(54) Shelf Stable Natural Cheese Product

(71) Applicant: Megan Lynne Nahinu Hull, Portland, OR (US)

(72) Inventor: Megan Lynne Nahinu Hull, Portland, OR (US)

(21) Appl. No.: 19/231,462

(22) Filed: Jun. 7, 2025

Related U.S. Application Data
(60) Provisional application No. 63/678,996, filed on Aug. 2, 2024.

(51) Int. Cl. A23C 19/09; A23B 11/60; A23C 19/076

(52) U.S. Cl. CPC A23C 19/0925; A23B 11/602; A23C 19/0765

(57) ABSTRACT

The present disclosure pertains to a novel cheese composition and the method for its preparation, wherein the cheese product is characterized by its shelf-stability, squeezability, and spreadability, while being entirely comprised of natural ingredients and electrolytes. These electrolytes are essential for maintaining hydration and supporting overall health, making the product not only a flavorful choice but also a beneficial one for consumers. This disclosure addresses the inherent challenges with cheese preservation, which typically hinge on the use of refrigeration or the addition of artificial preservatives to prevent spoilage of taste or quality. This disclosure discusses achieving this preservation through the acidification process, a critical element in ensuring the shelf stability of the cheese product.

### CONTINUITY AND CLAIM OF PRIORITY

This is a U.S. non-provisional patent application claiming the benefits and priorities of co-pending U.S. provisional Patent Application Ser. No. 63/678,996 filed on Jul. 11, 2024, which is incorporated herein.

### FIELD OF INVENTION

The present application relates to a shelf stable cheese product, in particular one that is squeezable and spreadable without the need for refrigeration.

### BACKGROUND

Cheese products are a popular food choice for those across all walks of life due to their rich flavors and versatility. However, typical cheese products require refrigeration to maintain their freshness and to prevent spoilage. Various methods have been employed to extend the shelf life of cheese products, including the use of artificial preservatives, pasteurization, and vacuum sealing. Despite these efforts, maintaining the stability and quality of cheese without the need refrigeration remains a significant challenge to the industry.

### SUMMARY

The present disclosure pertains to a novel cheese composition and the method for its preparation, wherein the cheese product is characterized by its shelf-stability, squeezability, and spreadability, while being entirely comprised of natural ingredients and electrolytes. These electrolytes are essential for maintaining hydration and supporting overall health, making the product not only a flavorful choice but also a beneficial one for consumers. This disclosure addresses the inherent challenges with cheese preservation, which typically hinge on the use of refrigeration or the addition of artificial preservatives to prevent spoilage of taste or quality. This disclosure discusses achieving this preservation through the acidification process, a critical element in ensuring the shelf stability of the cheese product.

### BRIEF DESCRIPTION OF THE DRAWING

To better understand the invention, the teachings of this application will be explained in greater detail with reference to the example embodiments shown in the drawings, in which:

FIG. 1 is an illustration of a flowchart for the preparation of a shelf-stable, squeezable, and spreadable cheese product, according to embodiments.

### DETAILED DESCRIPTION

This disclosure pertains to a cheese product distinguished by its novel ability to remain shelf-stable, squeezable, and spreadable without refrigeration or the addition of artificial additives, while retaining a favorable taste. This product, in embodiments, addresses longstanding issues in cheese preservation and providing a natural, practical, and nutritious alternative to traditional cheese offerings. Unlike conventional cheese products that depend on refrigeration or artificial additives for preservation, the cheese product embodiments described in this disclosure attain stability through a controlled acidification process that preserves both the structure of cheese as well as its desirable taste and texture.

Most commercially available cheese products that do not require refrigeration are reliant on the use of artificial preservatives or extensive processing to prevent spoilage, which can compromise the natural flavor and nutritional value of the cheese. Acidification, a common method of preserving many foods, has generally been viewed as unsuitable for cheese due to the occurrence of curdling, where the acid causes the liquid to separate from the solid components in the cheese, resulting in an undesirable taste and texture. This limitation has hindered the development of a shelf-stable, natural cheese product that maintains a desirable consistency and flavor without the need for refrigeration.

What is therefore needed is a cheese product that overcomes these limitations by being shelf stable, squeezable, and spreadable while maintaining its texture and flavor without the need for refrigeration or the inclusion of artificial preservatives. This product would provide a convenient, nutritious option for consumers, especially for those with an active or on-the-go lifestyle, without the need for refrigeration to maintain desirable taste or quality.

The cheese product embodiments discussed herein may be formulated exclusively from natural ingredients, including specific cheeses, dairy components, seasonings, and acidulants. In certain embodiments, the cheese product may be formulated exclusively from natural ingredients. The cheeses used in the composition may include, but are not limited to, extra sharp cheddar and Manchego cheese, contributing to the rich and complex flavor profile. In certain embodiments, the primary cheeses may be extra sharp cheddar and Manchego cheese. In certain embodiments, the Manchego cheese may be aged 6 months. In other embodiments, the Manchego cheese may be aged 12 months. In further embodiments, the extra sharp cheddar may aged 15 months. Other variations may include cheeses such as Gouda, Parmesan, Fontina, or other cheese types, each imparting unique flavors and textures to the final product.

The dairy components of the product provide a creamy base and enhance the product's smooth texture. In certain embodiments, the dairy components may include half-and-half and powdered cream cheese. Alternative dairy components may include heavy cream, milk, yogurt, or other dairy products depending on the desired consistency and nutritional profile of the cheese product. These variations allow for customization in flavor and texture, and catering to different consumer preferences. In certain embodiments, evaporated milk may be used in a 1:1 ratio with half-and-half, or any suitable ratio preferred by consumers or that may be preferable for cost savings. This substitution may offer flexibility in the dairy base, allowing for components to be utilized depending on production and commercial considerations. For commercialization purposes, the formulation may favor the use of evaporated milk to achieve the desired texture and shelf-stability.

The cheese product may incorporate seasonings. For example, seasonings such as salt, garlic, and thyme may be selected to complement the cheeses' natural flavors and balance the acidity introduced by the acidulants. In embodiments, the seasonings may include salt, garlic, and thyme. Additional seasoning variations may include herbs such as rosemary, basil, or oregano, as well as spices like black pepper, paprika, or cumin, to create diverse flavor profiles. However, any suitable herb and/or flavor combination may be utilized. The inclusion of these seasonings and flavorings may not only enhance the taste but also contribute to the overall sensory experience of the product.

Citric acid may serve as the primary acidulant, effectively lowering the pH to below the 4.2 threshold, thereby ensuring microbiological stability while preventing curdling or spoilage, as many common forms of pathogens and microorganisms struggle to survive at that pH. In certain embodiments, other acidulants such as lactic acid, tartaric acid, or malic acid may be used, either alone or in combination, to achieve the desired pH and stability. The choice of acidulant can influence the flavor and preservation characteristics of the cheese product, providing flexibility in formulation to meet specific consumer and production requirements. To mitigate the acidity that results from maintaining the pH at 4.2 or lower, a CLEAR MASK agent is incorporated into the formulation. In embodiments, the CLEAR MASK agent is a CLEAR MASK agent having flavor formula 518, including acidic vinegar notes and astringent off notes. This mask neutralizes the sour quality of acetic acid in vinegar. This agent effectively balances the tartness introduced by the acidulants, ensuring the cheese product retains its rich, savory flavor profile without an overpowering acidic taste. While we contemplate the use of CLEAR MASK flavor masks herein, any suitable flavor mask product may be used, according to effectivity, quality, and/or cost concerns.

In the final formulation, the concentrations of citric acid and/or sodium citrate may be expressed as a percentage of the overall product. These concentrations have been carefully determined to optimize pH and stability and are maintained consistently across production batches, according to embodiments. An example embodiment below illustrates an example of the specific percentages utilized to ensure reliability, consistency, and constancy in flavor and characteristics preservation.

The cheese product may be designed to endure extreme temperature variations, maintaining its texture and quality even when exposed to both freezing and/or warm conditions. These attributes may allow for easy restoration to a suitable eating temperature through simple kneading of the package if frozen. This is achieved through one or more of: the controlled acidification process, precise thermal processing, the use of emulsifiers and stabilizers, protective packaging, and/or the careful selection of natural ingredients, one or more of which work together to preserve its structural integrity and sensory qualities.

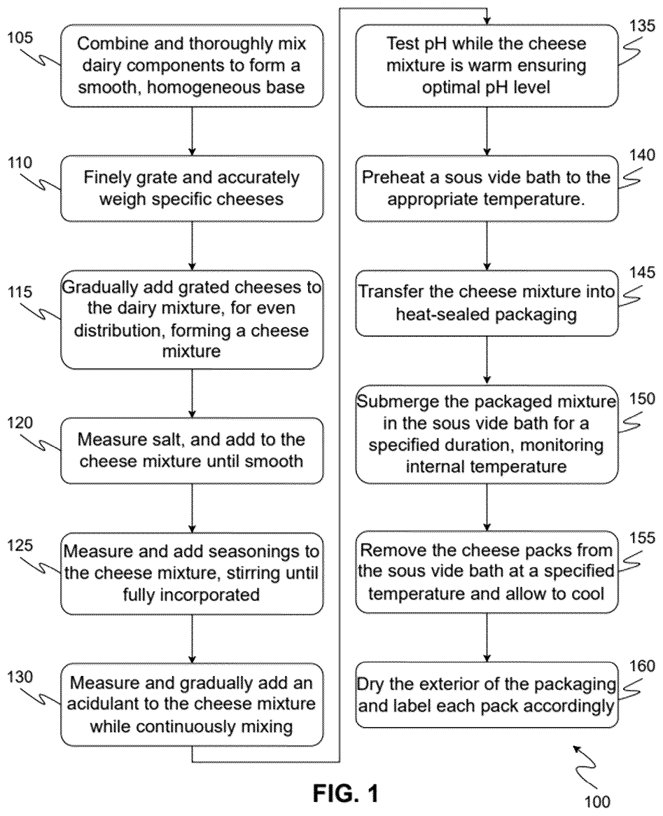

Referring to FIG. 1, illustrated is a flowchart outlining an example method 100 of the steps involved in the preparation of a shelf-stable, squeezable, and spreadable cheese product, according to embodiments. The method 100 of preparation of the cheese product may involve several steps for achieving the desired characteristics of the final product. Initially, at step 105, the dairy components, such as half-and-half and powdered cream cheese, are mixed to form a uniform base. This step involves combining the dairy components and mixing thoroughly until the powdered cream cheese is fully dissolved and a homogeneous mixture is achieved. The mixture should be smooth, with no visible lumps or inconsistencies.

At step 110, specific cheeses are finely grated or otherwise reduced to suitable particulates. The specific cheeses, in embodiments, are extra sharp cheddar and aged Manchego cheese, which are finely particulated, for example, using a food processor equipped with a fine grater attachment. The cheeses may be weighed with precision using a scale to ensure exact quantities. At step 115, the grated cheeses are incorporated into the dairy mixture forming a cheese mixture. The finely particulated cheeses are added to the dairy mixture gradually, ensuring even distribution throughout. The mixing process should be continuous, mixer to achieve a uniform blend.

The seasonings, including salt, garlic, and thyme, are measured precisely using a scientific scale, according to embodiments. Seasonings can be added in any order. In one embodiment, at step 120, salt is measured and added to the cheese mixture until smooth. At step 125, other seasonings are measured and added to the cheese mixture, stirring until fully incorporated. The mixture should be smooth, with the seasonings thoroughly blended into the cheese mixture, ensuring that all ingredients are evenly distributed. Along with the seasonings, the cheese product is enriched with naturally occurring electrolytes, such as potassium, calcium, and sodium, which contribute to its nutritional value.

These electrolytes, including calcium, potassium, and magnesium, are primarily derived from the dairy components and cheeses components of the cheese product. These ingredients naturally contain essential minerals that support hydration and other aspects of overall health. The processes of acidification and thermal treatment are designed to retain these nutrients, ensuring that the product remains a flavorful choice while providing significant nutritional benefits. This makes the cheese product not only a delicious option but also a beneficial one for consumers seeking to maintain electrolyte balance and hydration.

The next step in the process is the acidification process to ensure shelf stability. This is done at step 130, and involves the addition of an acidulant to the cheese mixture. The acidulant is measured added gradually while continuously mixing. The cheese mixture is stirred for an extended period to ensure the acidulant is evenly distributed and the pH is uniformly adjusted. The target pH for the cheese mixture is below 4.2, which is verified at step 135 using a pH meter. The mixture should be tested while at around room temperature to ensure accurate pH readings.

The controlled acidification process not only ensures microbiological stability but also maintains the cheese's desirable texture and flavor. By carefully managing the pH level, the product prevents curdling and spoilage, which is a common issue with dairy products. This results in a smooth, homogenous cheese product that can be easily squeezed or spread, offering a pleasant sensory experience. This, in embodiments, is done without the use edible inorganic acid and/or metal acid salt.

Following acidification, the cheese mixture undergoes thermal processing to ensure microbiological stability at 140, according to embodiments. This involves preheating a sous vide bath, or other suitable warming apparatus, to the appropriate temperature. At step 145, the cheese mixture is then transferred into food-grade polyester film stick packs, such as MYLAR, which are designed to be slim, lightweight, and portable. The packs are heat-sealed to prevent contamination and preserve product integrity.

At step 150, the sealed packs are placed into vacuum-sealed bags, and submerged in the preheated sous vide bath for a specified duration. During this thermal processing step, it is crucial to monitor the internal temperature of the cheese packs using a thermometer to ensure they reach the required temperature for microbial stability. Maintaining the correct temperature and time parameters ensures that any potential microbial contaminants are effectively eliminated, extending the product's shelf life without compromising its quality. According to embodiments, other thermal processing techniques and/or apparatuses may be employed, so long as they are configured to maintain the thermal properties of the cheese mixture according to the method described herein.

After the thermal processing is complete, at step 155, the cheese packs are removed from the sous vide bath and allowed to cool. Finally, at step 160, the exterior of the packaging is dried to remove any moisture, and each pack is labeled accordingly. This final step not only ensures the product's microbiological stability but also prepares it for distribution and consumption. The result is a shelf-stable, squeezable, and spreadable cheese product that retains its texture and flavor without the need for refrigeration.

In one example of an embodiment, the method of preparation includes the following detailed steps and specific measurements:

TABLE 1

| Ingredient | Weight (g) | Percentage (%) |
|---|---|---|
| Extra sharp cheddar | 10.85454919 | 33.9205 |
| Manchego | 7.626874872 | 23.8340 |
| Half and Half | 9.420027271 | 29.4376 |
| Powdered cream cheese | 2.343052468 | 7.3220 |
| Citric Acid | 0.390110266 | 1.2191 |
| Malic Acid | 0.230519703 | 0.7204 |
| Sodium citrate | 0.354645697 | 1.1083 |
| Sodium hexametaphosphate | 0.354645697 | 1.1083 |
| Sodium caseinate | 0.354645697 | 1.1083 |
| Pectin | 0.046103941 | 0.1441 |
| Clear mask flavor 518 | 0.024825199 | 0.0776 |
| Totals | 32 | 100.00 |

In this embodiment, 9.42 grams of half-and-half and 2.34 grams of powdered cream cheese are combined in a mixing bowl. The mixture is stirred thoroughly until the powdered cream cheese is fully dissolved, resulting in a smooth, homogeneous base with no visible lumps or inconsistencies. Next, 10.85 grams of extra sharp cheddar and 7.62 grams of aged Manchego cheese are finely grated using, for example, a food processor equipped with a fine grater attachment. The shredded cheeses are weighed with precision using a scientific scale to ensure exact quantities. The finely shredded cheeses are gradually added to the dairy mixture, ensuring even distribution throughout the base. The mixing process is continuous, utilizing a metal blade mixer in the food processor to achieve a uniform blend.

The acidification process requires adding 0.39 grams of citric acid to the cheese mixture. The citric acid is measured accurately using a scientific scale and added gradually while continuously mixing. The mixture is stirred for an extended period, a minimum of six minutes, to ensure the citric acid is evenly distributed and the pH is uniformly adjusted. The target pH for the cheese mixture is below 4.2, which is verified using a pH meter while the mixture is warm, at approximately 77° F.

Following acidification, the cheese mixture undergoes thermal processing. A sous vide bath is preheated to 165° F. The cheese mixture is transferred into food-grade MYLAR stick packs, each containing one ounce of the mixture. In embodiments, the packs are food grade MYLAR stick packs with narrowing at top for easy eating on the go. In further embodiments, the cheese product is packaged in dark-colored pouches with a laminate barrier, effectively protecting the cheese from oxidation. This packaging design enhances the shelf stability of the product by minimizing exposure to light and air, thereby preserving the cheese's natural flavor and nutritional integrity. The packs are heat-sealed to prevent contamination and preserve the product's integrity. The sealed packs are then placed into vacuum-sealed bags and submerged in the preheated sous vide bath for approximately five minutes. During this time, the internal temperature of the cheese packs is monitored using a thermometer to ensure it reaches at least 163° F.

In other embodiments, the formulation includes sodium citrate and caseinate, which function as emulsifiers and stabilizers. These components synergistically interact with each other and sodium hexametaphosphate (SHMP) to maintain the protein, fat, and moisture in solution during heating, thereby preserving the product's fluffy, homogeneous texture.

After the thermal processing is complete, the cheese packs are removed from the sous vide bath and allowed to cool. The exterior of the packaging is dried to remove any moisture, and each pack is labeled accordingly. The final product is a shelf-stable, squeezable, and spreadable cheese product that retains its texture and flavor without the need for refrigeration. In one embodiment, each 32-gram serving of the cheese product provides approximately 100 calories. This offers a balanced nutritional profile, delivering essential nutrients and energy in a convenient, calorie-controlled package.

In another example embodiment, the method of preparation includes the following detailed steps and specific measurements for a plain cheese product:

Initially, 9.4200 grams of evaporated milk and 2.3431 grams of powdered cream cheese are combined in a mixing bowl to form a uniform base. The evaporated milk is used in a 1:1 ratio with half-and-half; however, for commercialized embodiments, evaporated milk is preferred to achieve the desired texture and shelf-stability.

Next, specific cheeses, including 10.8545 grams of extra sharp cheddar and 7.6269 grams of Manchego, are finely grated. The cheeses are weighed with precision using a scale to ensure exact quantities. The grated cheeses are then incorporated into the dairy base, forming a cheese mixture. The finely shredded cheeses are added gradually, ensuring even distribution throughout the base. The mixing process should be continuous, using a metal blade mixer in the food processor, to achieve a uniform blend.

The acidification process involves the addition of 0.3901 grams of citric acid and 0.2305 grams of malic acid to the cheese mixture. These acids are measured accurately using a scientific scale and added gradually while continuously mixing. This ensures the mixture reaches the target pH level, maintaining microbiological stability.

Then, 0.3546 grams of sodium citrate and 0.3546 grams of sodium caseinate are added to serve as emulsifiers and stabilizers. These components, in conjunction with 0.3546 grams of sodium hexametaphosphate, work together to maintain protein, fat, and moisture in solution during heating, preserving the product's fluffy, homogeneous texture.

In addition, 0.0461 grams of pectin is incorporated to enhance the spreadability and consistency of the cheese product, contributing to its smooth texture. Finally, 0.0248 grams of a CLEAR MASK flavor agent is added to balance the acidity, ensuring the cheese retains its rich, savory flavor profile without an overpowering acidic taste. Following the mixing and acidification steps, the cheese mixture undergoes thermal processing as described above. The mixture is transferred into food-grade MYLAR stick packs, designed for ease of use and portability. The packs are heat-sealed to prevent spoilage.

The sealed packs are placed into vacuum-sealed bags and submerged in a preheated sous vide bath for a specified duration. During this thermal processing step, it is crucial to monitor the internal temperature of the cheese packs using a thermometer to ensure they reach the required temperature for microbial stability. Maintaining the correct temperature and time parameters ensures that any potential microbial contaminants are effectively eliminated, extending the product's shelf life without compromising its quality.

After the thermal processing is complete, the cheese packs are removed from the sous vide bath and allowed to cool. The exterior of the packaging is dried to remove any moisture, and each pack is labeled accordingly. This final step not only ensures the product's microbiological stability but also prepares it for distribution and consumption. The result is a shelf-stable, squeezable, and spreadable cheese product that retains its texture and flavor without the need for refrigeration.

The plain cheese product offers a versatile and balanced cheese product without additional flavoring agents. This variant comprises extra sharp cheddar cheese, evaporated milk, aged Manchego cheese, and powdered cream cheese, forming a creamy and flavorful base. The plain variant relies on its natural ingredients to deliver a rich cheese taste without overpowering seasonings. Pectin is included to ensure a smooth and spreadable texture, while natural flavoring agents enhance the cheeses' inherent qualities. The stabilization of the product is achieved through the use of citric acid, trisodium citrate dihydrate, sodium hexametaphosphate, and sodium caseinate, which work together to maintain its stability and texture. The plain variant serves as a foundational cheese product suitable for a wide range of culinary applications or as a standalone snack. For this embodiment, in terms of nutrition, each 32-gram serving of the plain flavor contains 120 calories, 9 grams of total fat, 6 grams of saturated fat, 25 milligrams of cholesterol, 330 milligrams of sodium, 2 grams of total carbohydrates of which 1 gram is from total sugars, and 6 grams of protein. It contains no trans fats or sugars and provides 5.8 micrograms of vitamin D, 160 milligrams of calcium, 0.1 milligrams of iron, and 50 milligrams of potassium.

In addition to the plain cheese product described in the previous embodiment, alternative flavors have been developed using the plain cheese product as the base formula. These flavors include garlic, spicy, and thyme, and each variant follows a similar preparation method to the plain cheese product, with specific seasonings added to achieve the desired flavor profiles.

The garlic flavor incorporates garlic powder into the base formula to provide a robust and savory garlic taste. The garlic flavor variant features garlic powder as the primary seasoning component, delivering a robust and savory garlic taste. The cheese base comprises extra sharp cheddar cheese, evaporated milk, aged Manchego cheese, and powdered cream cheese, ensuring a rich and creamy texture. Garlic powder is precisely measured and incorporated into the cheese mixture, providing an even and consistent garlic flavor throughout the product. The formulation includes pectin to enhance spreadability, while natural flavoring agents complement the garlic profile. Citric acid, trisodium citrate dihydrate, sodium hexametaphosphate, and sodium caseinate are used to stabilize the product and maintain its desirable texture. This garlic-flavored variant appeals to consumers who enjoy bold and savory cheese products with a pronounced garlic taste. Nutritionally, for this embodiment, each 32-gram serving of the garlic flavor offers 120 calories, 9 grams of total fat, 6 grams of saturated fat, 25 milligrams of cholesterol, 330 milligrams of sodium, 2 grams of total carbohydrates of which 1 gram is from total sugars, and 6 grams of protein. It is free from trans fats and sugars and provides 5.8 micrograms of vitamin D, 160 milligrams of calcium, 0.1 milligrams of iron, and 50 milligrams of potassium.

The spicy flavor introduces a combination of ancho chili powder and paprika, giving the cheese a mild heat and rich, smoky undertone. The spicy flavor variant of the cheese product includes specific ingredients that contribute to its unique taste profile. The formulation comprises extra sharp cheddar cheese, evaporated milk, aged Manchego cheese, and powdered cream cheese as the primary cheese and dairy components. To achieve the desired spicy flavor, chili powder and paprika are incorporated into the mixture. The inclusion of paprika adds a smoky depth to the cheese, while the chili powder provides a mild heat that enhances the overall sensory experience. Additionally, the formulation contains pectin to improve the texture and spreadability, as well as natural flavoring agents that balance the spiciness. The combination of citric acid, trisodium citrate dihydrate, sodium hexametaphosphate, and sodium caseinate ensures microbiological stability and maintains the product's texture. This variant offers a robust and savory option for consumers seeking a flavorful cheese product with a kick of spice. Each 32-gram serving of the spicy flavor provides 120 calories, 9 grams of total fat, 6 grams of saturated fat, 25 milligrams of cholesterol, 330 milligrams of sodium, 2 grams of total carbohydrates of which 1 gram is from total sugars, and 6 grams of protein. In this embodiment, the product contains no trans fats or sugars and includes 5.7 micrograms of vitamin D, 160 milligrams of calcium, 0.1 milligrams of iron, and 50 milligrams of potassium, contributing to its nutritional value.

The thyme flavor is enhanced with ground thyme, adding a delicate herbal note to the cheese product. The thyme flavor variant incorporates thyme as the key seasoning ingredient, adding an aromatic and herbal note to the cheese product. This variant includes extra sharp cheddar cheese, evaporated milk, aged Manchego cheese, and powdered cream cheese, forming the cheese base. Thyme is measured and blended into the cheese mixture to ensure even distribution of flavor. The formulation is further enhanced with pectin to achieve a smooth and spreadable consistency, while natural flavoring agents round out the flavor profile. Stabilizers such as trisodium citrate dihydrate, sodium hexametaphosphate, and sodium caseinate are used alongside citric acid and malic acid to maintain the product's stability and texture. This thyme-flavored variant offers a sophisticated taste option for consumers seeking a cheese product with a distinctive herbal character. A 32-gram serving of the thyme flavor provides 120 calories, 9 grams of total fat, 6 grams of saturated fat, 25 milligrams of cholesterol, 330 milligrams of sodium, 2 grams of total carbohydrates of which 1 gram is from total sugars, and 6 grams of protein. It contains no trans fats or sugars and provides 5.8 micrograms of vitamin D, 160 milligrams of calcium, 0.2 milligrams of iron, and 50 milligrams of potassium, supporting its nutritional benefits.

Each flavor variation may utilize the same cheese mixture formulation and preparation methods, ensuring consistency in texture and stability while providing diverse taste profiles to cater to different consumer preferences. The incorporation of these additional seasonings allows for customization without altering the foundational qualities of the cheese product. In embodiments, the cheese mixture may be adjusted to maintain pH and/or complement the flavor profile of the added flavorings.

Various embodiments of the cheese product can be formulated to cater to different consumer preferences and dietary needs. For instance, the flavors can be modified by adjusting the types and amounts of seasonings used, resulting in variations such as plain, spicy, bold, thyme, and garlic flavors. Additionally, the nutritional profile of the product can be tailored by varying the ratios of the primary ingredients, allowing for customization to meet specific dietary needs. These variations can include lower sodium options, higher protein content, or the inclusion of additional nutrients such as vitamins or minerals. In embodiments, each one-ounce pouch of the cheese product provides approximately 113 calories, including 10 grams of protein, 5 grams of fats, and 330 milligrams of salt, along with essential electrolytes to support energy and hydration. In other embodiments, each one-ounce pouch of the cheese product provides 100 calories with substantial protein, fat, and electrolytes. According to embodiments, pouches/packaging may be smaller or greater than one ounce, and the nutritional information may be adjusted to reflect the pouch contents and size.

Designed as a savory alternative, embodiments of the cheese product contain no added sugars, distinguishing it from typical sweet snacks such as energy gels, protein bars, and sports drinks. This makes it an ideal choice for athletes and health-conscious individuals who prioritize balanced nutrition and flavor without the extra sugar content often found in these products.

The cheese product may also be adapted for different packaging formats beyond the MYLAR stick packs. In certain embodiments, the product can be packaged in larger containers for family use or in single-serve cups for convenience. The packaging materials can be selected based on the desired shelf life, portability, and ease of use, ensuring that the product remains stable and retains its quality under various storage conditions.

Furthermore, the method of preparation can be adjusted to accommodate different production scales, from small-scale artisanal batches to large-scale industrial manufacturing. This flexibility ensures that the cheese product can be produced efficiently while maintaining its unique qualities. Alternative acidulants, such as lactic acid, tartaric acid, or malic acid, may also be explored to achieve the desired pH and stability, providing further customization options for flavor and preservation characteristics.

In addition to its primary use as a squeezable and spreadable cheese, the product can be incorporated into a variety of culinary applications. It can be used as a topping for snacks, a filling for sandwiches, or an ingredient in cooked dishes, offering versatility in its use. The product's stable, smooth texture and rich flavor make it suitable for a wide range of recipes, enhancing both the taste and nutritional value of meals.

By providing these various embodiments and customization options, the present disclosure ensures that the cheese product can meet diverse consumer demands and preferences, establishing it as a versatile and innovative addition to the market.

The innovative packaging design further contributes to the product's convenience and usability. The slim, lightweight MYLAR stick packs are easy to carry and use, making them perfect for on-the-go consumption. This packaging solution also provides excellent barrier properties, protecting the cheese from environmental factors that could compromise its quality. In other embodiments, alternative packaging formats can be employed to cater to different usage scenarios, from individual servings to family-sized containers. In further embodiments, the cheese product is packaged in dark-colored pouches with a laminate barrier to protect the cheese from oxidation. This enhances the shelf stability of the cheese product, minimizes exposure to light and air, and preserves the cheese's natural flavor and nutritional integrity.

Additionally, the cheese product's versatility in culinary applications enhances its value. It can be used as a standalone snack, a spread for sandwiches, or an ingredient in various recipes, providing flexibility for consumers to enjoy it in multiple ways. The product's rich flavor and smooth texture make it a valuable addition to both simple and complex dishes, contributing to its wide-ranging appeal.

By addressing the limitations of traditional cheese preservation methods and offering a product that is both convenient and nutritious, the present disclosure represents a significant advancement in the field of dairy products. It provides a solution that meets the needs of modern consumers, who seek high-quality, portable, and natural food options.

The scientific basis for the stability and preservation of the cheese product lies in the controlled acidification process. Acidification is a well-established method for preserving various food products, but its application in dairy products, particularly cheese, is challenging due to the risk of curdling and/or spoilage. The present disclosure overcomes this challenge by carefully managing the acidification process to maintain the cheese's structural integrity and desirable texture.

The primary mechanism involves the addition of an acidulant, such as citric acid, an organic acid, to the cheese mixture. By lowering the pH to below 4.2, the acidulant ensures microbiological stability, inhibiting the growth of spoilage organisms and pathogens. In embodiments, the selection of citric acid is critical as it effectively reduces the pH while preserving the cheese's smooth and homogeneous texture. In embodiments, other acidulants such as lactic acid, tartaric acid, or malic acid may also be used, either alone or in combination, to achieve the desired pH and stability.

During the acidification process, it is essential to maintain continuous mixing to ensure the even distribution of the acidulant throughout the cheese mixture. This prevents localized areas of high acidity that could lead to curdling. The process is further refined by monitoring the pH level with precision, using a pH meter to ensure the target pH is consistently achieved.

Thermal processing, such as sous vide cooking, complements the acidification by providing an additional layer of microbiological control. Heating the cheese mixture to a specific temperature for a defined period eliminates any residual microbial contaminants, further extending the product's shelf life. The combination of acidification and thermal processing ensures that the cheese product remains stable, safe, and high quality over extended periods without refrigeration.

The innovative packaging also plays a crucial role in the product's stability. Food-grade MYLAR stick packs provide a protective barrier against environmental factors such as oxygen, moisture, and light, which can degrade the product over time. Vacuum sealing the packs enhances this protection by removing air, which could harbor spoilage organisms and cause oxidation. This packaging method, combined with the controlled acidification and thermal processing, ensures the product maintains its quality and shelf stability.

The controlled acidification process, complemented by thermal processing and innovative packaging, forms the scientific foundation for the stability and preservation of the cheese product. This comprehensive approach addresses the inherent challenges of preserving cheese without refrigeration, providing a natural, convenient, and nutritious food option for consumers.

In summary, the present disclosure provides a significant advancement in the field of dairy products, presenting a naturally preserved, shelf-stable cheese that offers convenience, nutritional value, and excellent sensory qualities without the need for refrigeration. This innovative product is particularly suited for consumers with active lifestyles or limited access to refrigeration, fulfilling a critical demand in the market for portable and wholesome food options.

The present disclosure, as described herein, encompasses a multitude of innovative features and functionalities that extend beyond the methods and compositions for creating a shelf-stable, squeezable, and spreadable cheese product. For further details on the methods and compositions described herein, additional information can be found in the accompanying appendix. This appendix may further reveal an array of supplementary embodiments, variations, and/or alternative implementations, all crafted to enhance the overall utility, nutritional value, and consumer appeal of the product.

It will be appreciated that the invention is not restricted to the particular embodiments that have been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A shelf stable spreadable cheese product, with ingredients comprising:
cheese;
a dairy solution;
powdered cream cheese;
a citric compound;
a malic compound;
emulsifiers;
pectin;
a masking agent; and
seasonings.

2. The shelf stable spreadable cheese product according to claim one, wherein the dairy solution includes one or more of half and half and evaporated milk.

3. The shelf stable spreadable cheese product according to claim one, wherein the citric compound includes at least citric acid.

4. The shelf stable spreadable cheese product according to claim one, wherein the malic compound includes at least malic acid.

5. The shelf stable spreadable cheese product according to claim one, wherein the emulsifiers include one or more of sodium citrate and caseinate.

6. The shelf stable spreadable cheese product according to claim one, wherein the masking agents include at least CLEAR MASK 518.

7. The shelf stable spreadable cheese product according to claim 1, wherein the cheese product is produced entirely of natural ingredients.

8. The shelf stable spreadable cheese product according to claim 1, wherein the product's low water activity, low pH, salt content, and hermetic packaging results in a shelf stable cheese product with a shelf life of least six months.

9. A method of creating a shelf stable spreadable cheese product, comprising:
combining a set of dairy products to create a cheese mixture;
adding a set of shredded cheeses, the set shredded finely enough to ensure even distribution throughout the cheese mixture;
continuously mixing the cheese mixture utilizing a metal blade mixer;
adding a salt into the cheese mixture;
adding one or more acidulents into the cheese mixture;
continuously stirring the cheese mixture until the pH of the mixture is below 4.2;
transferring the cheese mixture into heat-sealed stick packs;
heating the cheese mixture in the heat-sealed stick packs to an internal temperature of at least 165 degrees Fahrenheit via a sous vide bath; and
removing the vacuum sealed packs from the sous vide bath.

10. A method of storing a shelf stable spreadable cheese product, comprising:
placing the cheese mixture into vacuum sealed packs, wherein the cheese mixture comprises:
cheese;
a dairy solution;
powdered cream cheese;
a citric compound;
a malic compound;
emulsifiers;
pectin;
a masking agent;
seasonings; and
emulsifiers, including one or more of sodium citrate and caseinate.
